(19) United States
(12) Patent Application Publication
(10) Pub. No.: US 2026/0209126 A1
(43) Pub. Date: Jul. 23, 2026

(54) PROCESS FOR MANUFACTURING A SHAPED SI-SIC ARTICLE, SHAPED ARTICLE, AND USE

(71) Applicants: Schunk Kohlenstofftechnik GmbH, Heuchelheim (DE); Schunk Ingenieurkeramik GmbH, Willich (DE)

(72) Inventors: Florian Reichert, Hohenahr (DE); Philipp Gingter, Moenchengladbach (DE); Lars Schnetter, Wimbach (DE)

(21) Appl. No.: 19/141,269

(22) PCT Filed: Dec. 20, 2022
(86) PCT No.: PCT/EP2022/086986

§ 371 Date: Jun. 19, 2025

(51) Int. Cl. C04B 35/573; B28B 1/00; B28B 11/24; B33Y 10/00; B33Y 40/20; B33Y 70/10; B33Y 80/00; C04B 35/628; C04B 35/632

(52) U.S. Cl. CPC C04B 35/573; B28B 1/001; B28B 11/243; B33Y 40/20; B33Y 70/10; B33Y 80/00; C04B 35/62834; C04B 35/62839; C04B 35/62884; C04B 35/632; B33Y 10/00; C04B 2235/3826; C04B 2235/422; C04B 2235/428; C04B 2235/6026; C04B 2235/614; C04B 2235/656; C04B 2235/783; C04B 2235/9669

(57) ABSTRACT

A method for producing a shaped body and a shaped body. The method includes as the shaped body a green body being formed from a ceramic material based on silicon carbide using an additive manufacturing process, the green body being subsequently subjected to a high-temperature treatment and the silicon carbide being recrystallized as a result of the high-temperature treatment.

The invention relates to a method for producing a shaped body and a shaped body of recrystallized silicon carbide. Further, the invention relates to a use of reaction-bonded silicon-infiltrated silicon carbide for the production of recrystallized silicon carbide.

A shaped body of silicon carbide (SiC) is well-known from the state of the art and is used in particular in high-temperature applications.

A plurality of variants of materials with silicon carbide exists, including in particular recrystallized silicon carbide (RSiC) and reaction-bonded silicon-infiltrated silicon carbide (SiSiC).

Due to its comparatively very high temperature resistance, a shaped body formed from recrystallized silicon carbide is regularly used for high-temperature applications with an application temperature of >1400° C. A green body is typically manufactured for the production of this type of shaped body using a silicon carbide grain mixture comprising a coarse grain fraction and a fine grain fraction, for example in the slip casting process, such green body then being fired at comparatively very high temperatures of 2300° C. to 2500° C., comparatively smaller grains being dissolved and comparatively larger grains being formed or growing as a result of diffusion processes, so that a shaped body of a comparatively coarse-grained and porous ceramic, which no longer shows any material changes, including at high temperatures, is obtained as a result. The disadvantage here, however, is that the shaping of this type of shaped body is limited to ceramic shaping such as casting, pressing and injection molding. In particular, this type of shaped body cannot yet be produced by means of an additive manufacturing process or a 3D printing process. As a result, there are limited shaping options and geometries, and therefore a limited area of application of this type of shaped body.

A shaped body formed from reaction-bonded silicon-infiltrated silicon carbide, which is likewise used in high-temperature applications, is obtained, for example, by initially forming a base body of silicon carbide, which is subsequently saturated with a carbon black suspension and then infiltrated with (metallic) silicon. It is possible to produce the base body using an additive manufacturing process, as described, for example, in DE 10 2013 017 193A1. Advantageously, this type of shaped body can also be produced with a complex geometry. However, the disadvantage here is that this type of shaped body always has a proportion of free (metallic) silicon. Due to the melting point of the free (metallic) silicon, the field of application of this type of shaped body is therefore limited to an application temperature of <1400° C.

Therefore, the object of the present invention is to propose a method for producing a shaped body, a shaped body and a use that enlarges a field of application of the shaped body.

This object is attained by a method with the features of claim 1, a shaped body with the features of claim 19 and a use with the features of claim 23.

In the method according to the invention for producing a shaped body, a green body is formed from a ceramic material based on silicon carbide using an additive manufacturing process, the green body being subsequently subjected to a high-temperature treatment, the silicon carbide being recrystallized as a result of the high-temperature treatment.

According to the invention, it is provided that a green body is formed from a suitable ceramic material based on silicon carbide or a silicon carbide material or from silicon carbide using an additive manufacturing process or 3D printing process, so that a green body formed from the ceramic material based on silicon carbide or from the silicon carbide material or from the silicon carbide is obtained. Multiple process steps can be provided to form the green body, of which the use of the additive manufacturing process can also constitute just one process step. The use of the additive manufacturing process allows the green body or shaped body to be formed with a high degree of design freedom or diversity of shapes, so that the shaped body can basically also have a complex geometry and can therefore be used more widely.

According to the invention, it is further provided that the green body is subsequently subjected to a high-temperature treatment or annealing treatment or high-temperature annealing in such a way that the material or the silicon carbide material or the silicon carbide is recrystallized as a result of the high-temperature treatment. In other words, the silicon carbide is converted into recrystallized silicon carbide, so that a shaped body of recrystallized silicon carbide that can be used at application temperatures of >1400° C. is obtained.

As a result, the method according to the invention makes it possible to produce a shaped body with an enlarged area of application.

Advantageously, reaction-bonded silicon-infiltrated silicon carbide (SiSiC) can be used as silicon carbide or material to form the green body, so that the green body can be formed from the reaction-bonded silicon-infiltrated silicon carbide. This is basically suitable for processing in the context of additive manufacturing. The green body can be produced according to the method described in DE 10 2013 017 193A1.

Advantageously, a base body can be formed from a granulation having silicon carbide or primary silicon carbide using the additive manufacturing process when forming the green body. The base body can be built up monolithically in layers from a shapeless granulation using a physical or chemical hardening or melting process. The granulation can have a quantity of at least 95% silicon carbide or primary silicon carbide. An aver-age grain size can be 70 μm to 200 μm, for example. A binder, for example in the form of a resin, can be used for hardening.

In one embodiment of the method, the granulation or the silicon carbide of the granulation can have a coarse grain fraction and a fine grain fraction. According to this, it can be provided that a granulation with a bimodal grain size distribution is used in the additive manufacturing process. For example, additive manufacturing can then take place using fused filament fabrication (FFF). As a result of the high-temperature treatment or diffusion processes, fine grains of the fine grain fraction can then be dissolved and coarse grains of the coarse grain fraction can grow or form. The binder can co-form the fine grain fraction, or a silicon carbide precursor can be processed as a binder, from which the fine grain fraction can result.

Advantageously, the base body can be impregnated with a carbon suspension, in particular carbon black suspension or graphite suspension. The base body can then be saturated with the carbon suspension at least once.

Alternatively, carbon can be introduced into the base body by means of vapor deposition.

Further alternatively, the base body can be impregnated with a resin that can subsequently be converted into carbon. The conversion of the resin into carbon can take place by means of a temperature treatment, in particular by means of the high-temperature treatment.

Advantageously, the base body can be infiltrated with (metallic) silicon. Through a con-tact of the carbon with liquid or gaseous (metallic) silicon, secondary silicon carbide can then be formed in subsequent reaction firing, which can solidify the resulting engagement composite. The green body can thus be obtained. Preferably, the infiltration of the base body with the (metallic) silicon takes place after the impregnation of the base body with the carbon suspension or with the resin or after the introduction of the carbon into the base body.

Advantageously, the silicon carbide of the green body can then have primary silicon carbide that at least co-forms or forms a coarse-grain fraction and secondary silicon carbide that at least co-forms or forms a fine-grain fraction, the fine grains of the fine-grain fraction being dissolved and the coarse grains of the coarse-grain fraction being able to grow or form as a result of the high-temperature treatment or diffusion processes. In other words, the secondary silicon carbide, which is fine-grained compared to the primary silicon carbide, can form a kind of “sacrificial phase” for the subsequent recrystallization process. If the primary silicon carbide of the granulation already has a coarse-grain fraction and a fine-grain fraction, the fine-grain fraction of the primary silicon carbide of the granulation can co-form the fine-grain fraction of the green body. The coarse grain fraction of the green body can then be formed from the coarse grain fraction of the primary silicon carbide of the granulation.

Advantageously, free (metallic) silicon can be removed as a result of a (chemical) etching treatment or removed, in particular evaporated, as a result of the high-temperature treatment in such a way that the shaped body can be substantially free of the free (metallic) silicon. If the free (metallic) silicon remaining in the green body as a result of the infiltration with the (metallic) silicon is removed from the green body or shaped body in the high-temperature treatment, the shaped body thus obtained can then be used at application temperatures of >1400° C. Preferably, the free (metallic) silicon can be removed by means of a evaporation, preferably a vacuum evaporation. By removing the free (metallic) silicon, the shaped body is substantially or largely free of the free (metallic) silicon. Trapped silicon residue can remain in the shaped body. The mass fraction of free (metallic) silicon remaining in the shaped body should be well below 5%.

Advantageously, the free (metallic) silicon can be removed initially, it subsequently being possible to recrystallize the silicon carbide. This can therefore involve two separate process steps. However, both processes can also take place simultaneously in a joint process step.

Advantageously, the removal of the free (metallic) silicon can be performed at first process parameters, it being possible toperform the recrystallization at second process parameters that are at least partially different from the first process parameters. In the present case, the term “process parameter” refers in particular to temperature and/or pressure.

Advantageously, the silicon carbide can be sintered as a result of the high-temperature treatment. Silicon carbide grains can be sintered together as a result.

Advantageously, the high-temperature treatment can be performed at a temperature of ≥2000° C., preferably 2100° C. to 2500° C. The high-temperature treatment can take place in an oven or a process chamber. A dwell time in the oven or process chamber can be multiple hours.

Advantageously, the high-temperature treatment can be performed at a reduced atmospheric pressure, preferably under a vacuum. The high-temperature treatment can be performed at a pressure of 1 mbar to 300 mbar, for example.

Advantageously, binder jetting can be used as additive manufacturing process. However, other additive manufacturing processes are also conceivable or can be selected appropriately.

Advantageously, the silicon carbide can be converted into recrystallized silicon carbide (RSiC) as a result of the high-temperature treatment. In this way, a shaped body can be produced from recrystallized silicon carbide, which has a high temperature resistance, creep resistance and chemical resistance.

Advantageously, the shaped body can be coated with silicon carbide (SiC) by means of chemical vapor deposition (CVD) subsequent to the high-temperature treatment. Advantageously, the shaped body can then also be used in the semiconductor sector, in particular due to its corresponding purity. As a result of the fact that the shaped body is formed from recrystallized silicon carbide, there is a comparatively high degree of flexibility with regard to the selection of the downstream coating process.

The shaped body according to the invention involves a green body that is formed from a ceramic material based on silicon carbide using an additive manufacturing process, the green body being subsequently subjected to a high-temperature treatment, the silicon carbide being recrystallized as a result of the high-temperature treatment.

The shaped body according to the invention is therefore produced according to the method according to the invention.

Reference is made to the description of the advantages of the method according to the invention with regard to the advantageous effects of the shaped body according to the invention.

Advantageously, the shaped body can be substantially free of free (metallic) silicon.

Advantageously, the shaped body can be used for high-temperature applications with an application temperature of >1400° C., preferably >1500° C.

The shaped body can be a component, in particular a high-temperature component, such as a furnace component, or a component that can be used in the semiconductor industry, or can be formed in such a way.

Further advantageous embodiments of the shaped body result from the descriptions of features of the subclaims referring back to method claim 1.

According to the invention, reaction-bonded silicon-infiltrated silicon carbide (SiSiC) is used for the production of recrystallized silicon carbide (RSiC) for the formation of a shaped body or when a shaped body is formed, the reaction-bonded silicon-infiltrated silicon carbide being subjected to a high-temperature treatment in such a way that the reaction-bonded silicon-infiltrated silicon carbide is converted into the recrystallized silicon carbide.

In other words, according to the invention, reaction-bonded silicon-infiltrated silicon carbide, which is then converted into recrystallized silicon carbide, and not recrystallized silicon carbide, is used as the starting point in the formation of a shaped body.

This “detour” via the reaction-bonded silicon-infiltrated silicon carbide on the “way” to the formation of the shaped body to be formed from the recrystallized silicon carbide makes it possible to flexibly determine a shape of the shaped body by means of an additive manufacturing process, as, in contrast to the recrystallized silicon carbide, the reaction-bonded silicon-infiltrated silicon carbide can be flexibly processed by means of additive manufacturing. The processing can take place before the conversion.

Free (metallic) silicon can be removed or evaporated during the high-temperature treatment.

Supplementary reference is made to the description of the advantages of the method according to the invention with regard to the advantageous effects of the use according to the invention.

Further advantageous embodiments of the use result from the descriptions of features of the subclaims referring back to method claim 1.

1. A method for producing a shaped body comprising a green body being formed from a ceramic material based on silicon carbide using an additive manufacturing process, the method comprising subjecting the green body to a high-temperature treatment subsequent to the additive manufacturing process, and the silicon carbide being recrystallized as a result of the high-temperature treatment.

2. The method according to claim 1, wherein reaction-bonded silicon-infiltrated silicon carbide (SiSiC) is used as silicon carbide.

3. The method according to claim 1, wherein a base body is formed from a granulation having silicon carbide using the additive manufacturing process when the green body is formed.

4. The method according to claim 3, wherein the silicon carbide of the granulation has a coarse grain fraction and a fine grain fraction.

5. The method according to claim 3, wherein the base body is impregnated with a carbon suspension.

6. The method according to claim 3, wherein carbon is introduced into the base body by means of vapor deposition.

7. The method according to claim 3, wherein the base body is impregnated with a resin that is subsequently converted into carbon.

8. The method according to claim 5, wherein the base body is infiltrated with silicon.

9. The method according to claim 8, wherein the silicon carbide of the green body has primary silicon carbide that at least co-forms a coarse-grain fraction and secondary silicon carbide that at least co-forms a fine-grain fraction, fine grains of the fine-grain fraction being dissolved and coarse grains of the coarse-grain fraction growing as a result of the high-temperature treatment.

10. The method according to claim 8, wherein free silicon is removed as a result of an etching treatment or is removed as a result of the high-temperature treatment in such a way that the shaped body is substantially free of the free silicon.

11. The method according to claim 10, wherein the free silicon is initially removed, the silicon carbide subsequently being recrystallized.

12. The method according to claim 11, wherein the removal of the free silicon is performed at first process parameters, the recrystallization being performed at second process parameters that are at least partially different from the first process parameters.

13. The method according to claim 1, wherein the silicon carbide is sintered as a result of the high-temperature treatment.

14. The method according to one preceding claim 1, wherein the high-temperature treatment is performed at a temperature of ≥2000° C.,

15. The method according to claim 1, wherein the high-temperature treatment is performed at a reduced atmospheric pressure.

16. The method according to one claim 1, wherein binder jetting is used as additive manufacturing process.

17. The method according to claim 1, wherein silicon carbide is converted into recrystallized silicon carbide (RSiC) as a result of the high-temperature treatment.

18. The method according to claim 1, wherein the shaped body is coated with silicon carbide (SiC) by means of chemical vapor deposition (CVD) subsequent to the high-temperature treatment.

19. A shaped body, comprising: a green body being formed from a ceramic material based on silicon carbide using an additive manufacturing process, the green body being subsequently subjected to a high-temperature treatment, the silicon carbide being recrystallized as a result of the high-temperature treatment.

20. The shaped body according to claim 19, wherein the shaped body is formed in such a way that it is substantially free of free silicon.

21. The shaped body according to claim 19, wherein the shaped body is usable for high-temperature applications with an application temperature of >1400° C.

22. The shaped body according to one of claims 19, wherein the shaped body is a component, in particular a high-temperature component or a component that is usable in the semiconductor industry.

23. A method of using reaction-bonded silicon-infiltrated silicon carbide (SiSiC) for the production of recrystallized silicon carbide (RSiC) for forming a shaped body, comprising subjecting the reaction-bonded silicon-infiltrated silicon carbide to a high-temperature treatment in such a way that that the reaction-bonded silicon-infiltrated silicon carbide is converted into the recrystallized silicon carbide.
